(19) United States
(12) Patent Application Publication
(10) Pub. No.: US 2004/0205210 A1
(43) Pub. Date: Oct. 14, 2004

(54) Data sending/receiving system for enabling DoS countermeasure

(75) Inventor: Atsushi Hamano, Chiba (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Sony Corporation, Tokyo (JP)

(21) Appl. No.: 10/762,251

(22) Filed: Jan. 23, 2004

(30) Foreign Application Priority Data
Jan. 24, 2003 (JP) 2003-016641

(51) Int. Cl. G06F 15/16

(52) U.S. Cl. 709/230

(57) ABSTRACT

In a data sending/receiving system, in sending/receiving of plural sending packet PK between a normal sending apparatus 2 and a receiving apparatus 3 via the Internet 5, only when the number of times of unit attack of changed contents packet FPK sent to the receiving apparatus 3 exceeded a predetermined threshold value, DoS countermeasure packet BMPK in which identification information JP is added to each sending packet PK is sent/received. That is, when there is no DoS act, the identification information JP is not added to each sending packet PK. Therefore, processing loads on the sending apparatus 2, the intermediate node on the Internet 5 and the receiving apparatus 3 can be reduced. Thus, the transmission efficiency of the entire data sending/receiving system 1 can be improved.

### BACKGROUND OF THE INVENTION

1. Field of the Invention

The present invention relates to a sending apparatus and a receiving apparatus, and is applicable, for example, to a data sending/receiving system wherein a sending apparatus and a receiving apparatus are connected via the Internet.

2. Description of the Related Art

Heretofore, in the sending/receiving system according to the Japanese patent application No. 2002-263272 already disclosed by the present assignee, on the sending side, when encrypted packet being a sending object is transmitted, correctness proof information which is to prove correctness only to the receiving apparatus is added thereto in a unencrypted state, and then they are transmitted to the receiving apparatus via the Internet, and on the receiving side, only when the determined result that the correctness of the correctness proof information added to the above encrypted packet is kept is obtained, the encrypted packet is decoded.

Therefore, in the sending/receiving system, in Denial of Service (DoS) acts, if mass false packet generated by rewriting the sender address of the encrypted packet or the like is sent to the receiving apparatus, the above receiving apparatus can abandon the false packet before decoding based on the correctness proof information that the third party could not know. Thus, even if mass false packet is received, rapid processing can be realized.

However, in the sending/receiving system having such configuration, the correctness proof information is always added to encrypted packet irrespectively of the presence/absence of a DoS act and they are transmitted. Therefore, a processing load on the entire system when there is no DoS act remarkably increases. As a result, there has been a problem that transmission efficiency as the entire system deteriorates.

### SUMMARY OF THE INVENTION

In view of the foregoing, an object of the present invention is to provide a sending apparatus, a sending method, a receiving apparatus and a receiving method, that can improve transmission efficiency as the entire system.

The foregoing object of the present invention has been achieved by the provision of a sending/receiving system wherein sending packet generated based on a predetermined communication protocol is sequentially sent via a network, and identification information to make only the receiving side identify the packet is added to each sending packet only during the period that a request came from the receiving side being the sending object of the above sending packet.

In this case, since the identification information is not added to each sending packet during other than the period that the request came from the receiving side, processing loads on the sending means, correctness adding means and the intermediate node on the network can be reduced.

Furthermore, the foregoing object of the present invention has been achieved by the provision of a sending/receiving system wherein sending packet based on a predetermined communication protocol sequentially sent from the sending side via the network is received, and in thus received each sending packet, changed contents packet being sending packet in that the contents of the above packet are changed is detected, and addition of identification information to make only detecting means identify the packet to the sending packet is requested to the sending side according to the receiving state of the detected changed contents packet.

In this case, since the sending packet with the identification information is not sent from the sending side when the addition has not been requested to the sending side, processing loads on the sending apparatus and the intermediate node on the network can be reduced.

The nature, principle and utility of the present invention will become more apparent from the following detailed description when read in conjunction with the accompanying drawings in which like parts are designated by like reference numerals or characters.

### BRIEF DESCRIPTION OF THE DRAWINGS

In the accompanying drawings:

FIG. 1 is a schematic diagram showing the general configuration of a sending/receiving system applying the present invention;

FIG. 2 is a block diagram showing the configuration of a sending apparatus;

FIG. 3 is a schematic diagram showing the configuration of DoS countermeasure packet;

FIG. 4 is a schematic diagram showing the configuration of identification information;

FIG. 5 is a block diagram showing the configuration of a receiving apparatus;

FIG. 6 is a schematic diagram showing the configuration of request data;

FIG. 7 is a flowchart showing a sending processing procedure; and

FIG. 8 is a flowchart showing a receiving processing procedure.

### DETAILED DESCRIPTION OF THE EMBODIMENT

Preferred embodiments of the present invention will be described with reference to the accompanying drawings:

(1) General Configuration

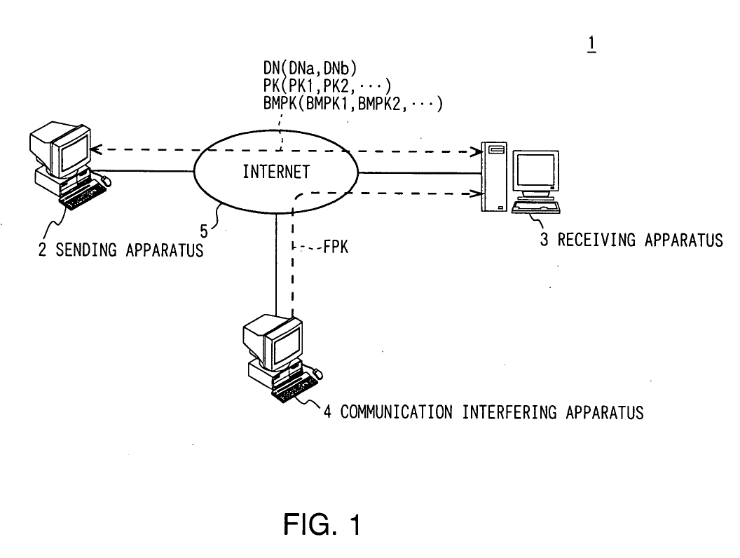

Referring to FIG. 1, reference numeral 1 generally shows a data sending/receiving system applying the present invention. A sending apparatus 2, a receiving apparatus 3 and a communication interfering apparatus 4 are connected to the Internet 5. A variety of data can be sent/received between the sending apparatus 2 and the receiving apparatus 3 via the Internet 5.

The sending apparatus 2 divides sending object data into data segments in a predetermined data length, performs packet encryption processing to the data segments according to a predetermined communication protocol, and transmits thus sequentially generated sending packet PK (PK1, PK2, . . . ) to the receiving apparatus 3.

The receiving apparatus 3 receives the sending packet PK transmitted from the sending apparatus 2, performs packet decoding processing to the sending packet PK according to the same communication protocol as the sending apparatus 2, and stores thus restored data segment for example in an internal memory (not shown).

The communication interfering apparatus 4 acts Denial of Service (DoS) on the receiving apparatus 3. To put it concretely, the communication interfering apparatus 4 monitors the sending packet PK (PK1, PK2 . . . ) sent from the sending apparatus 2 to th receiving apparatus 3, illegally obtains the above sending packet PK (PK1, PK2, . . . , or PKn) on transmission, generates sending packet FPP in that the contents-of the above obtained-sending packet PK are changed (hereinafter, this is referred to as changed contents packet), massively copies this, and then sequentially transmits them to the receiving apparatus 3.

Here, if the receiving apparatus 3 receives the mass changed contents packet FPK transmitted from the communication interfering apparatus 4, the receiving apparatus 3 generates request data DNa that requests the sender to start countermeasures for DoS acts (hereinafter, this is referred to as DoS countermeasure), and transmits this to the sending apparatus 2.

In this case, with respect to the sending packet PK sequentially generated after the receiving of the request data DNa from the receiving apparatus 3, the sending apparatus 2 adds identification information to prove correctness only to the receiving apparatus 3 thereto as a DoS countermeasure, and sequentially transmits thus sequentially obtained sending packet (hereinafter, this is referred to as DoS countermeasure packet) BMPK (BMPK1, BMPK2, . . . ) to the receiving apparatus 3.

In the DoS countermeasure packet BMPK sent from the sending apparatus 2 and the changed contents packet FPK sent from the communication interfering apparatus 4, the receiving apparatus 3 restores only the DoS countermeasure packet BMPK, and stores thus obtained data segment in the internal memory (not shown).

Then, if the changed contents packet FPK sent from the communication interfering apparatus 4 becomes less, the receiving apparatus 3 generates request data DNb that requests the sender to stop the DoS countermeasure, and transmits this to the sending apparatus 2.

In this case, if the sending apparatus 2 receives the request data DNb transmitted from the receiving apparatus 3, the sending apparatus 2 transmits sending packet PK sequentially generated after the receiving of the request data DNb as it is without adding the identification information, to the receiving apparatus 3.

In this manner, the sending/receiving system 1 requests the receiver to add or not to add identification information JP via the request data DN (DNa, DNb) according to the receiving state of the changed contents packet FPK in the receiving apparatus 3. Thereby, only when the number of times of receiving of the changed contents packet FPK is many (that is, the scale of the DoS act is large), the DoS countermeasure packet BMPK being the sending packet PK with the identification information can be transmitted from the sending apparatus 2 to the receiving apparatus 3 via the Internet 5.

Note that, in the sending/receiving system 1 in the embodiment of FIG. 1, in the case where one or more than two of sending apparatuses having the same configuration as the above sending apparatus 2 are connected to the receiving apparatus 3 via the Internet 5, in the plural sending apparatuses (including the sending apparatus 2, hereinafter, this is same), the receiving apparatus 3 can request only the sending apparatus 2 that sent the original sending packet PK of the changed contents packet FPK to add or not to add the identification information JP via the request data DN (DNa, DNb).

(2) Configuration of Sending Apparatus

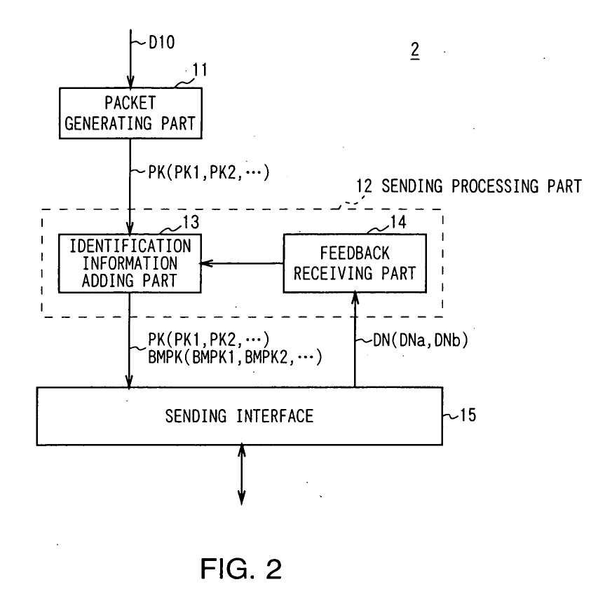

As shown in FIG. 2, a packet generating part 11 divides sending object data D10 read out from the internal memory or supplied from the outside into plural data segments in a predetermined length, and performs packet encryption processing to the data segment according to a communication protocol, for example, called the Internet Protocol security (IPsec).

To put it concretely, in various security information groups (security associations (SA)), such as plural cryptograph key information, encryption algorithm, authentication algorithm, prescribed by the IPsec, the packet generating part 11 encrypts the data segment according to the SA, the use of which was predetermined when the sending apparatus 2 first accessed to the receiving apparatus 3 based on the addresses of the sending apparatus 2 and the receiving apparatus 3, (hereinafter, this is referred to as using security), and then adds header thereto, and supplies thus sequentially generated sending packet PK (PK1, PK2, . . . ) to a sending processing part 12.

In this connection, in the above sending packet PK, index information called a security parameter index (SPI) showing the using security is also included.

When it is in a first mode in that identification information will not be added (hereinafter, this is referred to as DoS countermeasure stop mode), an identification information adding part 13 in the sending processing part 12 becomes into a pause state in that processing by the identification information adding part 13 itself stops.

Therefore, the sending packet PK (PK1, PK2, . . . ) sequentially supplied from the packet generating part 11 is transmitted to the receiving apparatus 3 (FIG. 1) as it is via the interface (hereinafter, this referred to as sending interface) 15.

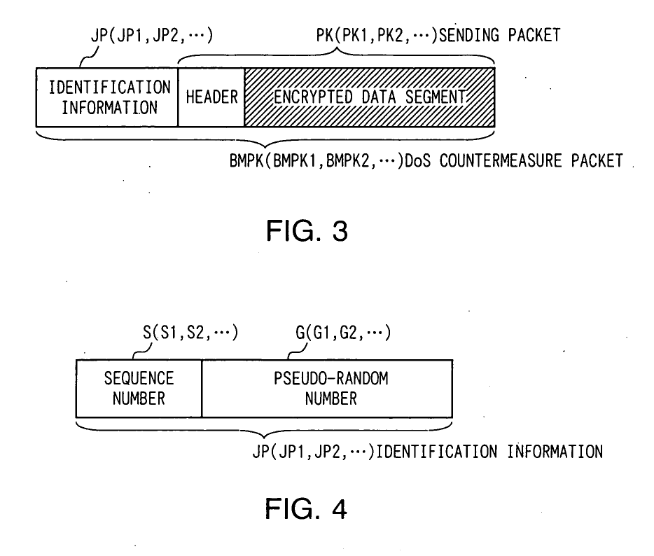

On the other hand, when it is in a second mode in that identification code will be added (hereafter, this is referred to as DoS countermeasure mode), the identification information adding part 13 first generates identification information JP (JP1, JP2, . . . ) peculiar to each sending packet PK (PK1, PK2, . . . ) supplied from the packet generating part 11, as shown in FIG. 3.

Next, the identification information adding part 13 adds the unencoded identification information JP to the sending packet PK in its forward direction, and transmits thus sequentially generated DoS countermeasure packet BMPK (BMPK1, BMPK2, . . . ) to the receiving apparatus 3 (FIG. 1) via the sending interface 15.

Here, as a concrete method of generating the identification information JP, the identification information adding part 13 first derives seed information (seed) based on the cryptograph key information used in the packet generating part 11, by identification information generation algorithm independently owned only by the sending apparatus 2 and the receiving apparatus 3 differently from the prescription of the IPsec previously stored in the internal memory (not shown).

Then, as shown in FIG. 4, the identification information adding part 13 generates a peculiar pseudo-random number G (G1, G2, . . . ) that cannot be known by the communication interfering apparatus 4 from the seed information (seed) and generates identification information JP (JP1, JP2, . . . ) by adding sequential number data S (S1, S2, . . . ) corresponding to the order of generation of the above pseudo-random number G (hereinafter, this is referred to as sequence number) to, for example, the head of the above pseudo-random number G.

Accordingly, not as well as can make the communication interfering apparatus 4 recognize the correspondence relationship between the pseudo-random number G and the sequence number S as simply random data row, the identification information adding part 13 can generate identification information JP (JP1, JP2, . . . ) in which a combination of the pseudo-random number G and the sequence number S never becomes the same. Therefore, the seed information (seed) can be generated as highly reliable identification information JP that can be almost certainly identified only by the receiving apparatus 3.

Furthermore, the identification information adding part 13 generates the identification information JP according to the identification information generation algorithm independently owned only by the sending apparatus 2 and the receiving apparatus 3, and then adds this to the sending packet PK in a unencoded state. Therefore, the identification information JP can be identified only by the receiving apparatus 3 (FIG. 1) before the sending packet PK is decoded.

A feedback receiving part 14 in the sending processing part 12 receives the request data DN (DNa, DNb) sent from the receiving apparatus 3 (FIG. 1). If receiving the request data DNa for starting the DoS countermeasure, the feedback receiving part 14 changes the identification information adding part 13 to the DoS countermeasure mode.

On the other hand, if receiving the request data DNb for stopping the DoS countermeasure, the feedback receiving part 14 changes the identification information adding part 13 to the DoS countermeasure stop mode.

The sending processing part 12 works the identification information adding part 13 only during the period from the receiving of the request data DNa to the receiving of the request data DNb as the above. Thus, a data processing load on the identification information adding part 13 can be reduced.

By the way, sending processing by the sending processing part 12 is realized by the cooperative operation of the CPU of the sending apparatus 2 (not shown) that reads out a predetermined sending program previously stored in a program storing memory (not shown) in the sending apparatus 2 on a work memory (not shown) and expands this, and the sending processing part 12. The description of the sending processing procedure will be described later.

(3) Configuration of Receiving Apparatus

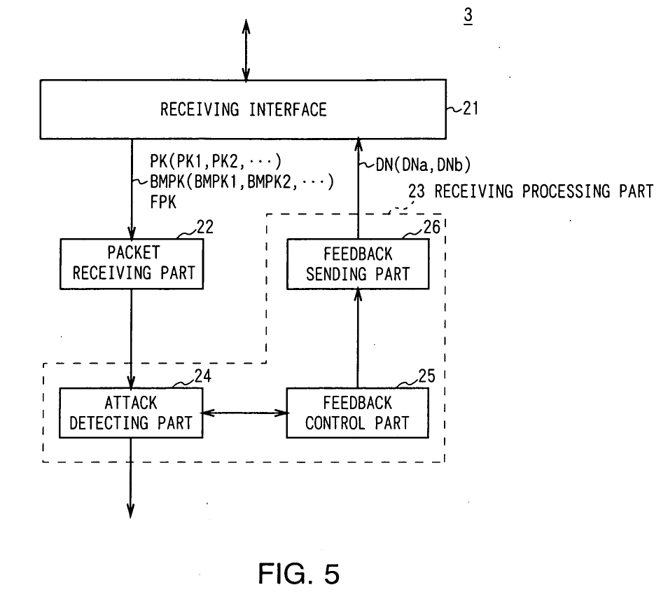

As shown in FIG. 5, a packet receiving part 22 receives packet (sending packet PK, DoS countermeasure packet BMPK or changed contents packet FPK) sequentially via the Internet 5 (FIG. 1) and the interface (hereinafter, this is referred to as receiving interface) 21, and supplies this to a receiving processing part 23.

If predetermined accesses to start packet sending come from plural sending apparatuses, an attack detecting part 24 in the receiving processing part 23 previously decides a using security between the receiving apparatus 3 and the above sending apparatus individually, and keeps on grasping the using security respectively corresponding to each sending apparatus.

Therefore, with respect to the packet supplied from the packet receiving part 22, the attack detecting part 24 retrieves the using security used for the above packet based on the sender address of the above packet and index information (SPI) included in the above packet, and it can specify for example the sending apparatus 2 corresponding to the above retrieved using security.

In this state, if the start of the DoS countermeasure has not been requested to the specified sending apparatus 2, the attack detecting part 24 executes packet decoding processing on the sending packet PK sent from the above sending apparatus 2 without the addition of the identification information JP in the first mode (hereinafter, this is referred to as the first attack detection mode).

To put it concretely, the attack detecting part 24 decodes the sending packet PK sent from the sending apparatus 2 according to the using security corresponding to the above sending apparatus 2.

Here, for example, if a decoding error such that a hash value normally to be obtained could not be obtained occurred, the attack detecting part 24 detects that the sending packet PK is changed contents packet FPK in that the contents of the original sending packet PK sent from the sending apparatus 2 are changed, notifies a feedback control part 25 of that the original sender of the above changed contents packet FPK is the sending apparatus 2, and abandons the above changed contents packet FPK.

On the contrary, as a result of the decoding of the sending packet PK, if encrypted data segment included in the sending packet PK (FIG. 3) is restored, the attack detecting part 24 stores the above data segment in the internal memory as data segment from the sending apparatus 2.

On the other hand, if the start of the DoS countermeasure has been requested to the sending apparatus 2, the attack detecting part 24 executes packet decoding processing on the DoS countermeasure packet BMPK sent from the above sending apparatus 2 with the identification information JP (FIG. 3) in the second mode (hereinafter, this is referred to as the second attack detection mode).

To put it concretely, the attack detecting part 24 determines whether or not the identification information JP is added to the head of the DoS countermeasure packet BMPK (FIG. 3) sent from the above sending apparatus 2.

If an affirmative result that the identification information JP is added is obtained, as the second stage, with respect to the sequence number S of the identification information JP (FIG. 4), the attack detecting part 24 determines whether or not it differs from the sequence numbers S of the past identification information JP that has been temporarily stored in the internal memory (not shown) for every sending apparatus.

If an affirmative result that the sequence number S differs from the sequence numbers S of the identification information JP received in the past is obtained, as the third stage, the attack detecting part 24 generates comparison identification information to be compared to the identification information JP by using the same seed information (seed) as the sending apparatus 2 by the same identification information generation algorithm as the sending apparatus 2, and then determines whether or not the collation result of the above identification information JP and the comparison identification information is coincident.

Here, in the case where a negative result was obtained in the first stage, identification information JP has not been added in spite of that the start of the DoS countermeasure was requested to the sending apparatus 2; it means to be illegal changed contents packet FPK in that the contents of the sending packet PK were changed.

In the case where a negative result was obtained in the second stage or the third stage, it means to be illegal changed contents packet FPK in that there is a change in the contents of the DoS countermeasure packet BMPK.

Therefore, if a negative result is obtained in only either one of the first, the second and the third stages, the attack detecting part 24 detects to be changed contents packet FPK, and informs the feedback control part 25 of that the original sender of the above changed contents packet FPK is the sending apparatus 2, and abandons the above changed contents packet FPK.

On the contrary, if an affirmative result is obtained in all of the first, the second and the third stages, the attack detecting part 24 decodes the sending packet PK according to the using security corresponding to the above sending apparatus 2, and stores thus restored data segment in the internal memory as data from the sending apparatus 2.

In this manner, in the first attack detection mode, the attack detecting part 24 manages data segments according to normal sending packet on the internal memory for every sending apparatus, and it can detect changed contents packet FPK for every sending apparatus, by retrieving the using security for every packet sequentially supplied from the packet receiving part 22, specifying the sending apparatus corresponding to the above using security, and then decoding the sending packet PK.

Furthermore, in the second attack detection mode, the attack detecting part 24 can detect changed contents packet FPK for every sending apparatus before decoding the sending packet PK, by specifying the sending apparatus similarly to the first attack detection mode, and then determining whether or not to be changed contents packet FPK based on the identification information JP added to the head of the sending packet PK in a unencoded state.

Accordingly, even if the receiving apparatus 3 received mass changed contents packet FPK from the communication interfering apparatus 4, the attack detecting part 24 can abandon it by simple processing with a small processing load without decoding it respectively. Thereby, a processing load on the receiving apparatus 3 can be remarkably reduced.

The feedback control part 25 in the receiving processing part 23 has a counter for every sending apparatus. The counter of the sending apparatus corresponding to a notice is sequentially advanced by “1” every time when the sending apparatus being the original sender of the changed contents packet FPK is notified by the attack detecting part 24, and the number of times of advance per predetermined unit time in each of the above counters (hereinafter, this is referred to as the number of times of unit attack) is calculated based on the internal clock.

In the above number of times of unit attack, when the value is large, it means that mass changed contents packet FPK was transmitted, that is, the scale of the DoS act is large. On the contrary, when the above value is small, it means that the scale of the DoS act is comparatively small.

Furthermore, when the number of times of unit attack of the counter became larger than a predetermined threshold value, the feedback control part 25 gives a feedback transmitting part 26 a DoS countermeasure start command to the sending apparatus corresponding to the above counter, and makes the attack detecting part 24 perform decoding in the second attack countermeasure mode when in decoding packet sent from the above sending apparatus.

On the contrary, if the number of times of unit attack of the counter becomes smaller than the predetermined threshold value, the feedback control part 25 gives the feedback sending part 26 a DoS countermeasure stop command, for example, to the sending apparatus corresponding to the above counter, and makes the attack detecting part 24 perform decoding in the first attack countermeasure mode when in decoding packet sent from the above sending apparatus.

Such predetermined threshold value will be changed according to the throughput of the receiving apparatus 3: almost 10-20[%] of the number of times of unit attack in that the receiving apparatus 3 becomes inoperable owing to a processing load uselessly consumed by that the receiving apparatus 3 in a decoding mode received mass changed contents packet FPK will be selected.

In this manner, the feedback control part 25 can switch the processing state in the attack detecting part 24 according to the number of times of unit attack of the counter.

The feedback sending part 26 generates request data DN (DNa or DNb) corresponding to the command given by the feedback control part 25, and transmits this for example to the sending apparatus 2 (FIG. 1) via the receiving interface 21.

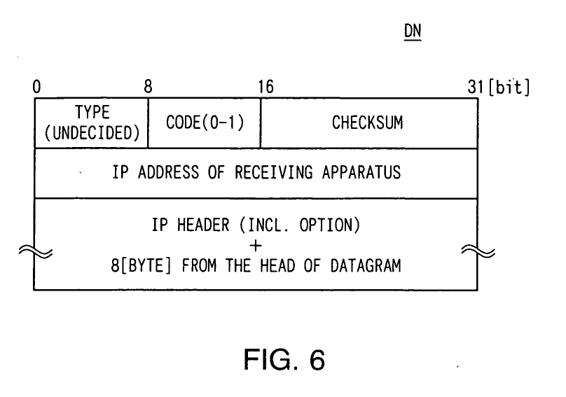

For example, as shown in FIG. 6, in a specification group called the Request for Comments (RFC), the Internet Control Message Protocol (ICMP) prescribed by the RFC792 is applied to the above request data DN (DNa and DNb).

In this case, in “code”, “0” or “1” will be described. If it is “1”, it means a DoS countermeasure start request, and if it is “0”, it means a DoS countermeasure stop request. In the sending apparatus 2, the DoS countermeasure start request or the DoS countermeasure stop request can be recognized based on “0” or “1” described in the above “code”.

In this connection, in “type”, a value which can be recognized in the receiving apparatus 3 and the sending apparatus 2 respectively will be described. And in “checksum”, a data row for that the sending apparatus 2 checks whether or not communication data-DN is broken will be described.

In this manner, the receiving processing part 23 counts the changed contents packet FPK for very sending apparatus to calculate the number of times of unit attack, and sends the request data DN (DNa or DNb) only to the sending apparatus in that the above calculation result exceeded or became smaller than the predetermined threshold value. Thereby, in plural sending apparatuses, the DoS countermeasure only in the sending apparatus being the original sender of the changed contents packet FPK can be started/stopped.

By the way, in the receiving processing by the receiving processing part 23, a receiving program corresponding to the sending program has been previously stored in the program storing memory (not shown) in the receiving apparatus 3. The receiving processing is realized by the cooperative operation of the CPU of the receiving apparatus 3 (not shown) that reads out the above receiving program on the work memory (not shown) in the receiving apparatus 3 and expands this, and the receiving processing part 23.

Hereafter, the sending processing procedure in the sending processing part 12 and the receiving processing procedure in the receiving processing part 23 will be described respectively with a flowchart.

(4) Sending Processing Procedure and Receiving Processing Procedure

(b 4-1) Sending-Processing Procedure

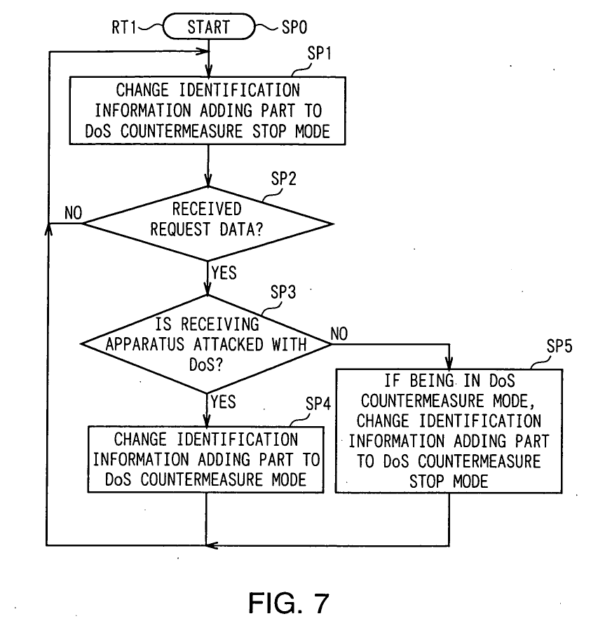

The sending processing procedure in the sending processing part 12 will be first described with a flowchart shown in FIG. 7.

If a predetermined sending operation such that sending object data D1 is transmitted to the receiving apparatus 3 is performed, the sending processing part 12 proceeds from the start step SP0 of a routine RT1 to the next step SP1.

In step SP1, the sending processing part 12 changes the identification information adding part 13 to the DoS countermeasure stop mode, and proceeds to the next step SP2.

In this case, the identification information adding part 13 is in a pause state. Therefore, the sending packet PK from the packet generating part 11 is supplied to the sending interface 15 as it is without the addition of the identification information JP (FIG. 4).

In step SP2, the sending processing part 12 determines whether or not the request data DN (DNa, DNb) sent from the receiving apparatus 3 (FIG. 1) was received, by the feedback receiving part 14. Here, if a negative result is obtained, this means that the request data DN has not been received yet. At this time, the sending processing part 12 awaits the request data DN until receiving.

On the contrary, if an affirmative result is obtained in step SP2, this means that the request data DN was received. At this time, the sending processing part 12 proceeds to the next step SP3.

In step SP3, the sending processing part 12 determines whether or not the receiving apparatus 3 (FIG. 1) is receiving a DoS act based on the data contents of the request data DN received in step SP2, by the feedback receiving part 14.

Here, if an affirmative result is obtained, this means that “1” has been described in “code” (FIG. 6) in the request data DN, that is, the DoS countermeasure start request came. At this time, the sending processing part 12 proceeds to the next step SP4.

In step SP4, the sending processing part 12 changes the identification information adding part 13 from the DoS countermeasure stop mode to the DoS countermeasure mode by the feedback receiving part 14. And then, the sending processing part 12 returns to step SP2 to await the request data DN until receiving.

In this case, the identification information adding part 13 adds the identification information JP (FIG. 4) to the sending packet PK supplied from the packet generating part 11 to generate the DoS countermeasure packet BMPK (FIG. 3), and supplies this to the sending interface 15.

On the contrary, if a negative result is obtained in step SP3, this means that “0” has been described in “code” (FIG. 6) in the request data DN, that is, the DoS countermeasure stop request came. At this time, the sending processing part 12 proceeds to the next step SP5.

In step SP5, in the case where the identification, information adding part 13 is in the DoS countermeasure mode, the sending processing part 12 changes the abov identification information adding part 13 from the DoS countermeasure mode to the DoS countermeasure stop mode by the feedback receiving part 14. And then, the sending processing part 12 returns to step SP2 to await the request data DN until receiving.

In this case, the identification information adding part 13 becomes to a pause state again. Therefore, the sending packet PK from the packet generating part 11 is supplied to the sending interface 15 as it is without the addition of the identification information JP (FIG. 4).

(4-2) Receiving Processing Procedure

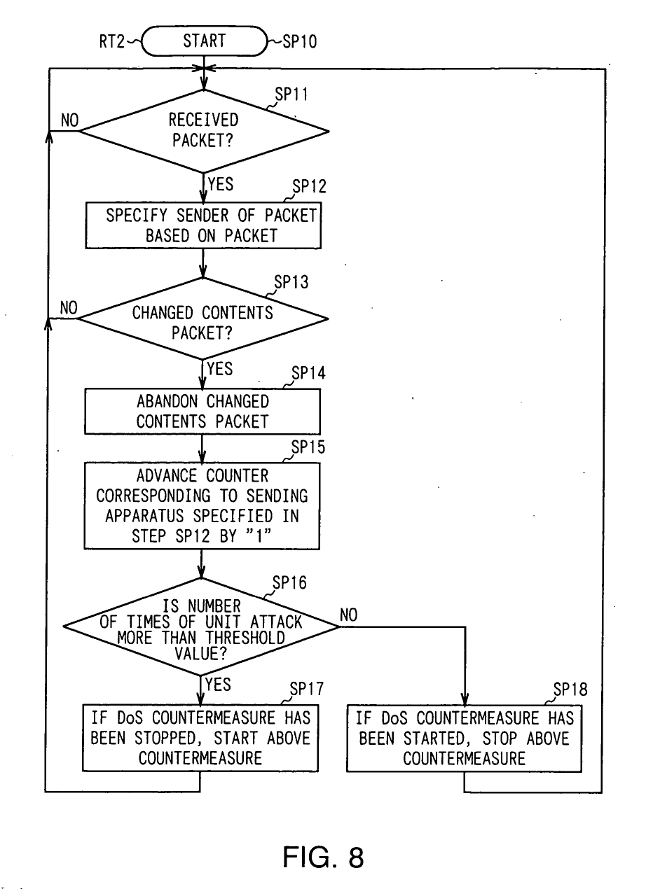

Next, the receiving processing procedure in the receiving processing part 23 will be described with a flowchart shown in FIG. 8.

The receiving processing part 23 proceeds from the start step SP10 of a routine RT2 to the next step SP11.

In step SP11, the receiving processing part 23 determines whether or not the packet receiving part 22 received packet (sending packet PK or changed contents packet FPK), by the attack detecting part 24.

Here, if a negative result is obtained, this means that th packet receiving part 22 does not receive packet yet. At this time, the receiving processing part 23 awaits packet until receiving.

On the contrary, if an affirmative result is obtained, this means that the packet receiving part 22 received the packet. At this time, the receiving processing part 23 proceeds to the next step SP12.

In step SP12, the receiving processing part 23 specifies for example the sending apparatus 2 that is the sender of the above packet, based on the packet received in step SP11, and proceeds to the next step SP13.

In step SP13, in the case where the DoS countermeasure has been stopped to the sending apparatus 2 specified in step SP12, the receiving processing part 23 executes packet decoding processing in the first attack detection mode. On the contrary, in the case where the DoS countermeasure has been started, the receiving processing part 23 executes the packet decoding processing in the second attack detection mode, and determines whether or not the packet received in step SP11 is changed contents packet FPK.

Here, if a negative result is obtained, this means that the packet received in step SP11 is normal sending packet PK or DoS countermeasure packet BMPK, sent from the sending apparatus 2 (FIG. 1). At this time, the receiving processing part 23 stores the data segment included in the above sending packet PK or DoS countermeasure packet BMPK in the internal memory as data segment from the sending apparatus 2, by the attack detecting part 24. And then, the receiving processing part 23 returns to step SP11 to await packet until receiving again.

On the contrary, if an affirmative result is obtained in step SP13, this means that the packet received in step SP11 actually is illegal changed contents packet FPK sent from the communication interfering apparatus 4 (FIG. 1). At this time, the receiving processing part 23 proceeds to the next step SP14.

In step SP14, the receiving processing part 23 abandons the changed contents packet FPK determined in step SP13, and informs the feedback control part 25 of that the origin of the changed contents packet FPK is the sending apparatus 2, by the attack detecting part 24. And then, the receiving processing part 23 proceeds to the next step SP15.

In step SP15, the receiving processing part 23 advances th counter corresponding to the sending apparatus 2 informed from the attack detecting part 24, that is, specified in step SP12, by “1” by the feedback control part 25, and proceeds to the next step SP16.

In step SP16, the receiving processing part 23 determines whether or not the number of times of unit attack calculated based on the counter advanced in step SP15 (the number of times of advance per unit time) is larger than the predetermined threshold value.

Here, if an affirmative result is obtained, this means that the receiving quantity of the changed contents packet FPK generated by rewriting the sender address or the like of the packet (sending packet PK or DoS countermeasure packet BMPK) sent from the sending apparatus 2 is large, that is, the scale of the DoS act is large. At this time, the receiving processing part 23 proceeds to the next step SP17.

In step SP17, in the case where the DoS countermeasure has been stopped in the sending apparatus 2, the receiving processing part 23 generates request data DNa for requesting the start of the DoS countermeasure and sends this to the sending apparatus 2 via the interface 21 by the feedback sending part 26. And then, the receiving processing part 23 returns to step SP11.

On the contrary, if a negative result is obtained in step SP16, this means that the receiving quantity of the changed contents packet FPK generated by rewriting the sender address or the like of the packet (sending packet PK or DoS countermeasure packet BMPK) sent from the sending apparatus 2 became smaller or became zero, that is, the scale of the DoS act became smaller or the DoS act has not been performed. At this time, the receiving processing part 23 proceeds to the next step SP18.

In step SP18, in the case where the DoS countermeasure has been started in the sending apparatus 2, the receiving processing part 23 resets the counter corresponding to the sending apparatus. 2 by the feedback control part 25, and generates request data DNb for requesting the stop of the DoS countermeasure and sends this to the sending apparatus 2 via the receiving interface 21 by the feedback sending part 26. And then, the receiving processing part 23 returns to step SP11.

In this connection, if the DoS countermeasure has been already started in the sending apparatus 2 in step SP17, and if the DoS countermeasure has been already stopped in the sending apparatus 2 in step SP18, the receiving processing part 23 returns to step SP11 without any processing.

(5) Operation and Effect

According to the above configuration, the sending apparatus 2 sequentially transmits sending packet PK generated based on the encryption protocol prescribed by the IPsec via the Internet 5, by the sending interface 15 served as sending means.

In this state, the sending apparatus 2 adds identification information JP to the sending packet PK only during the period requested by the receiving apparatus 3, being the sending object of the sending packet PK (that is, during the period from the receiving of request data DNa to the receiving of request data DNb), by the identification information adding part 13 served as means for adding identification information.

In this case, when the DoS countermeasure has not been requested by the receiving apparatus 3, the sending apparatus 2 sends the sending packet PK without adding the identification information JP. Therefore, processing loads on the sending apparatus 2 itself and the intermediate node such as a router on the Internet 5 can be reduced.

Furthermore, the sending apparatus 2 is in a pause state during other than the period that the DoS countermeasure has been requested by the receiving apparatus 3, so that when the DoS countermeasure has not been requested by the receiving apparatus 3, the sending apparatus 2 does not generate identification information JP. Therefore, a processing load on the identification information adding part 13 itself can be reduced, and power consumption can be saved.

On the other hand, the receiving apparatus 3 receives sending packet PK (DoS countermeasure packet BMPK) sequentially transmitted from the sending apparatus 2 via the Internet 5 by the receiving interface 21 served as receiving means, and detects changed contents packet FPK being the sending packet in that the contents of the above packet are changed by the attack detecting part 24 served as detecting means.

In this state, only in the case where the number of times of unit attack of the detected changed contents packet FPK exceeds the predetermined threshold value, the receiving apparatus 3 requests the sending apparatus 2 to add the identification information JP to the sending packet PK, by the feedback control part 25 and the feedback sending part 26, that will be served as request means.

In this case, if the DoS countermeasure has not been requested to the sending apparatus 2, DoS countermeasure packet BMPK with the identification information JP is not transmitted to the receiving apparatus 3 from the sending apparatus 2. Therefore, processing loads on the sending apparatus 2 itself and the intermediate node such as a router on the Internet 5 can be reduced.

Here, the receiving apparatus 3 determines whether or not the packet sent from the sending apparatus 2 is changed contents packet FPK based on the identification information JP composed of a pseudo-random number G and a sequence number S peculiar to the pseudo-random number G, according to the identification information generation algorithm peculiarly owned only by the sending apparatus 2 and the receiving apparatus 3. Thereby, the changed contents packet FPK can be detected only by recognizing the presence/absence of the above identification information JP (first stage), or by simply collating the sameness with the past sequence number S and pseudo-random number G.

In this case, the receiving apparatus 3 can detect the changed contents packet FPK by more simple processing with a smaller processing load than the case of detecting the changed contents packet FPK at the time of decoding the sending packet PK. Thereby, even if mass changed contents packet FPK was sent from the communication interfering apparatus 4, a processing load on the receiving apparatus 3 can be remarkably reduced. Thus, a system down or the like owing to the receiving of the mass changed contents packet FPK can be prevented.

Furthermore, the receiving apparatus 3 requests only the sending apparatus 2 that sent the sending packet PK relating to the changed contents packet FPK to add identification information JP to sending packet PK, in plural sending apparatuses. Thereby, in comparison with the case of requesting all of the plural sending apparatus to add the identification information JP, a processing load on the Internet 5 can be remarkably reduced.

According to the above configuration, in sending/receiving of plural sending packet PK between the normal sending apparatus 2 and receiving apparatus 3 via the Internet, only when the number of times of unit attack of the changed contents packet FPK sent to the receiving apparatus 3 exceeded a predetermined threshold value, DoS countermeasure packet BMPK in which the identification information JP is respectively added to the sending packet PK is sent/received. That is, when there is no DoS act, identification information JP is not added to each sending packet PK. Therefore, a processing load on the entire sending/receiving system 1 including the sending apparatus 2, the intermediate node on the Internet 5 and the receiving apparatus 3 can be reduced. Thus, the transmission efficiency of the entire system can be improved.

(6) Other Embodiments

In the aforementioned embodiment, it has dealt with the case where when the number of times of unit attack of the changed contents packet FPK received in the receiving apparatus 3 exceeded the predetermined threshold value, the DoS countermeasure is started. However, the present invention is not only limited to this but also a processing load on the CPU for integrally controlling the receiving apparatus may be monitored all the time, and when the processing load on the CPU exceeded a predetermined value, a DoS countermeasure may be started. In short, the DoS countermeasure can be started according to a receiving state in the receiving apparatus 3.

In the aforementioned embodiment, it has dealt with the case where the request data DN having the configuration aforementioned with FIG. 6 is applied. However, the present invention is not only limited to this but also request data having various configurations other than that can be applied to the present invention.

In the aforementioned embodiment, it has dealt with the case where the request data DN is transmitted via the Internet 5 being the network same as the sending packet PK. However, the present invention is not only limited to this but also request data DN and sending packet PK may be sent/received via a different network respectively. In short, such requesting method that when the receiving apparatus 3 requested the sending apparatus 2 to add identification information JP to sending packet PK, the sending apparatus 2 answers the above request can be selected.

In the aforementioned embodiment, it has dealt with the case where the present invention is applied to the IPsec being the communication protocol on the Internet 5. However, the present invention is not only limited to this but also it can be applied to various communication protocols other than that on other networks such as a communication protocol on the Internet such as SSH, a communication protocol on a local area network (LAN), a communication protocol on satellite broadcasting, a communication protocol on a teletext.

In the aforementioned embodiment, it has dealt with the case where sending processing by the sending processing part 12 (FIG. 2) is performed by the sending program, and the receiving processing by the receiving processing part 23 (FIG. 3) is performed by the receiving program. However, the present invention is not only limited to this but also the entire processing in each part in the sending apparatus 2 may be performed by a sending program or the entire processing in each part in the receiving apparatus 3 may be performed by a receiving program, and the above each part may be formed by a dedicated integrated circuit respectively.

Furthermore, in the aforementioned embodiment, it has dealt with the case where the sending processing is executed by the sending processing procedure aforementioned with FIG. 7 according to the sending program previously stored in the program storing memory, and the receiving processing is executed by the receiving processing procedure aforementioned with FIG. 8 according to the receiving program previously stored in the above memory. However, the present invention is not only limited to this but also sending processing and/or receiving processing may be executed by installing a sending program and/or a receiving program from a program storing medium storing them to an information processing apparatus.

In this case, such program storing medium used to install the sending program and/or the receiving program to the information processing apparatus and to make it executable is not only limited, for example, to packaged media such as a flexible disk, a compact disk read-only memory (CD-ROM), a digital video disc (DVD), but also it can be realized by a semiconductor memory, a magnetic disk, etc., in that a program can be temporarily or permanently stored. Furthermore, as the means for storing a sending program and/or a receiving program in such program storing medium, cable or wireless communication media such as a local ar a network, the Internet, digital satellite broadcasting may be used, and the program may be stored via various communication interfaces such as a router, a modem.

According to the present invention as described above, sending packet generated based on a predetermined communication protocol is sequentially sent via a network, and identification information to make only the receiving side identify the packet is added to each sending packet only during the period that a request came from the receiving side being the sending object of the above sending packet. Since the identification information is not added to each sending packet during other than the period that the request came from the receiving side, processing loads on the sending means, identification information adding means and the intermediate node on the network can be reduced. Thus, the transmission efficiency of the entire system can be improved.

Furthermore, according to the present invention as described above, sending packet based on a predetermined communication protocol sequentially sent from the sending side via the network is received, and in the above each received sending packet, changed contents packet being sending packet in that the contents of the above packet are changed is detected, and addition of identification information to make only detecting means identify the packet to the sending packet is requested to the sending side according to the receiving state of the detected changed contents packet. Since the sending packet with the identification information is not sent from the sending side when the addition is not requested to the sending side, processing loads on the sending apparatus and the intermediate node on the network can be reduced. Thus, the transmission efficiency of the entire system can be improved.

While there has been described in connection with the preferred embodiments of the present invention, it will be obvious to those skilled in the art that various changes and modifications may be aimed, therefore, to cover in the appended claims all such changes and modifications as fall within the true spirit and scope of the present invention.

What is claimed is:

1. A sending apparatus comprising:
sending means for sequentially sending sending packet generated based on a predetermined communication protocol via a network; and
identification information adding means for adding identification information to make only the receiving side identify said packet to each of said sending packet, only during the period requested by the above receiving side being the sending object of said sending packet.

2. The sending apparatus according to claim 1, wherein;
said identification information generating means adds said identification information to said sending packet in a unencoded state in its forward direction.

3. The sending apparatus according to claim 1, wherein;
said identification information is composed of a predetermined pseudo-random number and sequence number information peculiar to the above pseudo-random number.

4. A sending method comprising:
the first step for sequentially sending sending packet generated based on a predetermined communication protocol via a network; and
the second step for adding identification information to make only the receiving side identify said packet to each of said sending packet, only during the period requested by the receiving side of said sending packet.

5. A receiving apparatus comprising:
receiving means for receiving sending packet based on a predetermined communication protocol sequentially transmitted from the sending side via a network;
detecting means for detecting changed contents packet being said sending packet in that the contents of the above packet are changed, in each of said sending packet received by said receiving means; and
request means for requesting said sending side to add identification information to make only said detecting means identify said packet to said sending packet according to the receiving state of the changed contents packet detected by said detecting means.

6. The receiving apparatus according to claim 6, wherein;
said request means requests only said sending side that sent said sending packet relating to said changed contents packet to add said identification information to sending packet.

7. A receiving method comprising:
the first step for receiving sending packet based on a predetermined communication protocol sequentially transmitted from the sending side via a network;
the second step for detecting changed contents packet being said sending packet in that the contents of the above packet are changed, in each of said sending packet received by said first step; and
the third step for requesting said sending side to add identification information to make only said detecting means identify said packet to said sending packet, according to the receiving state of the changed contents packet detected by said second step.
